(19) United States
(12) Patent Application Publication
(10) Pub. No.: US 2026/0262013 A1
(43) Pub. Date: Sep. 3, 2026

(54) INFORMATION PROCESSING SYSTEM, SERVER, USER TERMINAL, AND SERVICE PROVIDING METHOD

(71) Applicant: Innovative Space Carrier Inc., Tokyo (JP)

(72) Inventors: Kosuke OGURA, Kanagawa (JP); Rie KATO, Kanagawa (JP); Keiichiro SHIMADA, Boulder, CO (US)

(21) Appl. No.: 19/551,935

(22) Filed: Feb. 27, 2026

Related U.S. Application Data
(60) Provisional application No. 63/764,656, filed on Feb. 28, 2025.

(51) Int. Cl. H04W 64/00; H04N 7/18

(52) U.S. Cl. CPC H04W 64/003; H04N 7/183

(57) ABSTRACT

An information processing system includes a server and a user terminal, wherein the server includes circuitry configured to cause the user terminal to display, on one screen, data from a satellite, the data being current position information of the satellite with respect to Earth and at least one of measurement data or video data.

### CROSS-REFERENCE TO RELATED APPLICATION

This application claims the benefit of U.S. Provisional Application No. US 63/764,656, filed Feb. 28, 2025, the entire contents of which are incorporated herein by reference.

### TECHNICAL FIELD

The disclosures herein relate to information processing systems, servers, user terminals, and service providing methods.

### BACKGROUND ART

A technology for acquiring a video recording and the like captured in outer space and viewing the video recording on Earth is disclosed.

However, in the related art, a user is only able to view a video recording or the like captured in outer space and is unable to determine a position of the satellite at which such video recordings were captured.

Therefore, the present disclosure aims to facilitate the user’s recognition of data from the satellite and position information of the satellite.

### Citation List

### Patent Literatures

[PTL 1] Japanese Patent No. 6990458

[PTL 2] Japanese Laid-Open Patent Publication No. 2024-55925

### SUMMARY OF THE INVENTION

An information processing system includes a server and a user terminal, wherein the server includes circuitry configured to cause the user terminal to display, on one screen, data from a satellite, the data being current position information of the satellite with respect to Earth and at least one of measurement data or video data.

### EFFECT OF THE INVENTION

According to the present disclosure, the user’s recognition of data from the satellite and position information of the satellite is facilitated.

### BRIEF DESCRIPTION OF THE DRAWINGS

FIG. 1 is a drawing illustrating an overall configuration according to one embodiment of the present disclosure;

FIG. 2A is a drawing illustrating a configuration of a satellite when each device is mounted as one unit;

FIG. 2B is a drawing illustrating a configuration of a satellite when each device is mounted separately;

FIG. 3 is a drawing illustrating an internal configuration of the satellite according to one embodiment of the present disclosure;

FIG. 4 is a functional block diagram illustrating a server and a user terminal according to one embodiment of the present disclosure;

FIG. 5 is a sequence diagram illustrating acquisition of measurement data and video data and instructions specifying a measurement condition and a video-recording condition according to one embodiment of the present disclosure;

FIG. 6 is a drawing illustrating an example of a screen displayed on the user terminal according to one embodiment of the present disclosure;

FIG. 7 is a drawing illustrating an example of the screen displayed on the user terminal according to one embodiment of the present disclosure;

FIG. 8 is a drawing illustrating an example of the screen (screen displaying a position of the satellite with respect to Earth) displayed on the user terminal according to one embodiment of the present disclosure;

FIG. 9A is a drawing illustrating an image of a product taken against a background of outer space;

FIG. 9B is a drawing illustrating an image of a doll (figure) taken against the background of outer space;

FIG. 9C is a drawing illustrating an image of a video recording of the doll (figure) projected on a liquid crystal monitor or a hologram projector arranged in the satellite;

FIG. 10 is a drawing illustrating a communication medium when communication conditions between the satellite and a ground station are poor according to one embodiment of the present disclosure;

FIG. 11 is a drawing illustrating the communication medium when the communication conditions between the satellite and the ground station are poor according to one embodiment of the present disclosure; and

FIG. 12 is a hardware configuration diagram illustrating the server and the user terminal according to one embodiment of the present disclosure.

### DESCRIPTION OF THE PREFERRED EMBODIMENTS

In the following, embodiments of the present disclosure will be described with reference to the accompanying drawings.

### Overall Configuration

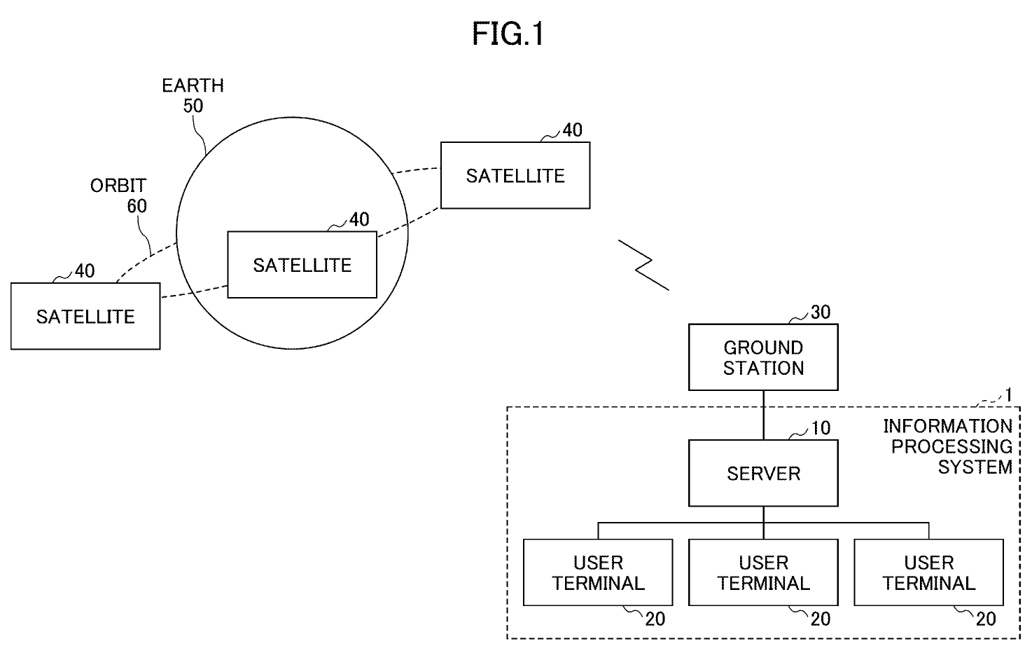

FIG. 1 is a drawing illustrating an overall configuration according to one embodiment of the present disclosure. An information processing system 1 includes a server 10 and user terminals 20 (although FIG. 1 shows a case where there are three user terminals, a number of the user terminals is not limited to this).

### Server

The server 10 acquires at least one of measurement data and video data from a satellite 40 and transmits the data acquired from the satellite 40 to the user terminal 20. The server 10 acquires an instruction specifying at least one of a measurement condition and a video-recording condition for the satellite 40 from the user terminal 20 and transmits the instruction specifying the condition acquired from the user terminal 20 to the satellite 40. The server 10 can transmit and receive data to and from the user terminal 20 and a ground station 30 via any network. The server 10 includes one or more computers.

### User Terminal

The user terminal 20 is a terminal operated by the user. The user can view measurement data and video data from the satellite 40 on a screen displayed on the user terminal 20 and can specify a desired measurement condition and a desired video-recording condition for the satellite 40. For example, the user terminal 20 is a personal computer, a tablet, a smartphone, or the like.

### Ground Station

The ground station 30 (although FIG. 1 illustrates a case in which the server 10 transmits and receives data to and from a single ground station, the server 10 may transmit and receive data to and from a plurality of ground stations) includes a parabolic antenna and a transceiver located on the ground for communicating with a satellite 40.

### Satellite

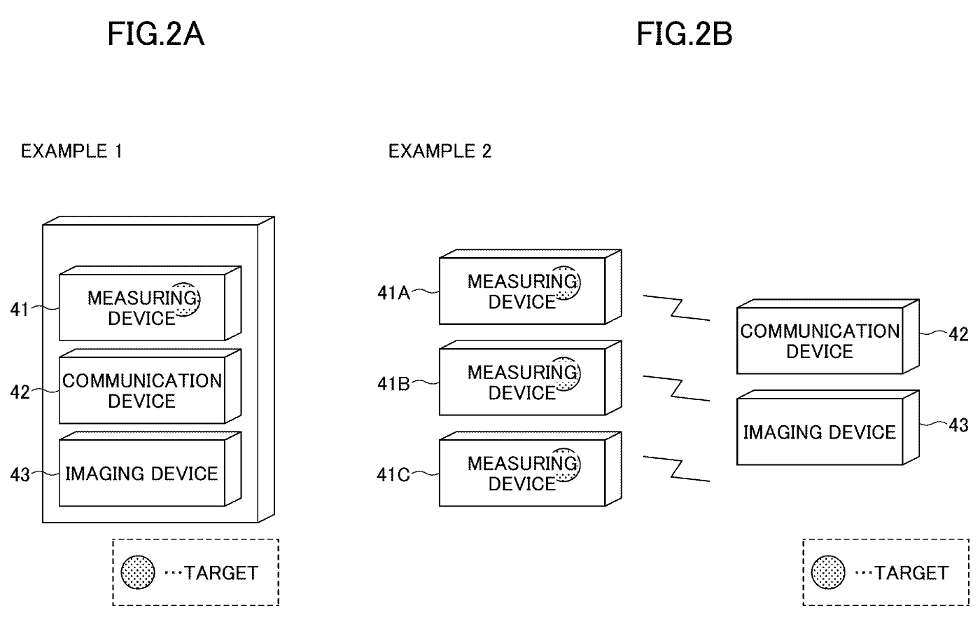

Satellites 40 (FIG. 1 shows a case where there are three satellites, but the number of satellites is not limited to this) travel along an orbit 60 around Earth 50. The satellite 40 transmits various data to the ground station 30 and receives various data from the ground station 30. For example, an object such as a product of a company or a doll (also referred to as a figure) is mounted on the satellite 40. The satellite 40 will be described in detail later with reference to FIGS. 2A and 2B.

FIGS. 2A and 2B are drawings illustrating a configuration of the satellite 40 according to one embodiment of the present disclosure. In Example 1, each device (also referred to as a module) is implemented as one unit, and in Example 2, each device is implemented separately.

In Example 1, a measuring device 41, a communication device 42, and an imaging device 43 are implemented in a single satellite. That is, a single satellite including the measuring device 41, the communication device 42, and the imaging device 43 travels along the orbit 60 around Earth 50. The satellite further includes a control device that controls the measuring device 41, the communication device 42, the imaging device 43, and the like, as well as a power supply device, which may use solar panels.

An object (e.g., company product, doll (figure)) is mounted on the measuring device 41. The measuring device 41 may be provided with a sensor for measuring the object. Further, the measuring device 41 may be provided with a robot arm (capable of being operated in accordance with a predetermined operation or an instruction from the user terminal 20 on the ground) for moving the object.

The communication device 42 communicates (transmits and receives data) with the ground station 30 on Earth. The communication device 42 transmits a result of measuring the object mounted on the measuring device 41 and the video recording captured by the imaging device 43 to the ground station 30.

The imaging device 43 captures an image of the object mounted on the measuring device 41.

In Example 2, the measuring device 41, the communication device 42, and the imaging device 43 are separately implemented. That is, each of the measuring device 41, the communication device 42, and the imaging device 43 travels along the orbit 60 around Earth 50. Each of the measuring device 41, the communication device 42, and the imaging device 43 further includes the control device as well as a power supply device, which may use solar panels. In Example 2, the measuring device 41 is simply referred to as a satellite.

An object (e.g., company product, doll (figure)) is mounted on the measuring device 41 (e.g., it may be a 20 cm × 20 cm × 30 cm rectangular prism). The measuring device 41 may include a sensor for measuring the object. Further, the measuring device 41 may include the robot arm (capable of being operated in accordance with a predetermined operation or an instruction from the user terminal 20 on the ground) for moving the object. In Example 2, the measuring device 41 transmits the result measured by the measuring device 41 to the communication device 42.

The communication device 42 performs communication (data transmission and reception) with the ground station 30 on Earth. In Example 2, the communication device 42 receives the result of measuring the object mounted on each of the plurality of measuring devices 41 from the plurality of measuring devices 41 and transmits the result to the ground station 30. The communication device 42 also receives the video recording captured by the imaging device 43 and transmits the video recording to the ground station 30.

The imaging device 43 captures images of the object mounted on each of the plurality of measuring devices 41 and outer space (including Earth, the moon, stars, etc.). In Example 2, the imaging device 43 transmits the video recording captured by the imaging device 43 to the communication device 42.

As in Example 2, the data from the satellite may be data measured or captured at each of a plurality of satellites (i.e., the measuring device 41) and acquired by the ground station 30 from one communication device 42. In this case, it is preferable that the measuring device 41 has a transparent portion (e.g., at least a portion of at least one surface of a rectangular prism is transparent) so that a video recording of the inside of the measuring device 41 can be captured.

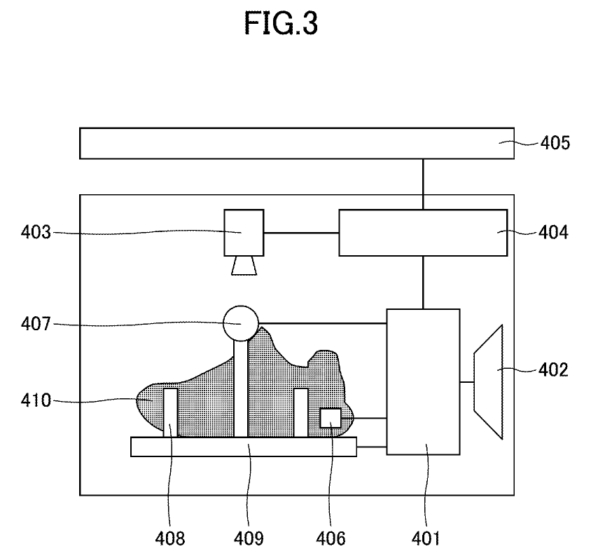

FIG. 3 is a drawing illustrating an internal configuration of the satellite of Example 1 of FIG. 2A. The satellite is a rectangular prism and has a transparent portion (at least a portion of at least one surface of the rectangular prism is transparent) as described above, so that the imaging device (camera) 403 can simultaneously capture an image of the object and space from inside the satellite. Electric power obtained by the solar panel 405 arranged on one surface outside the rectangular prism is supplied to the power supply device 404 to supply electric power to each component inside. An object 410 is held on a stage 409 via a holding unit 408. The measuring device (various sensors) 406, the communication device (communication with the ground station 30 or other satellite) 402, the imaging device 403, and the robot arm 407 are controlled by a control device 401.

In Example 2 of FIG. 2B, the measuring devices 41A to 41C, the communication device 42, and the imaging device 43 are configured as separate satellites, but the measuring devices 41A to 41C also have the solar panel 405, the power supply device 404, the control device 401, the stage 409, the holding unit 408, and the robot arm 407 as in FIG. 3. Further, the measuring devices 41A to 41C may include an imaging device 403 for capturing an image of the object 410, a communication device 402 for communicating with another satellite, and the like.

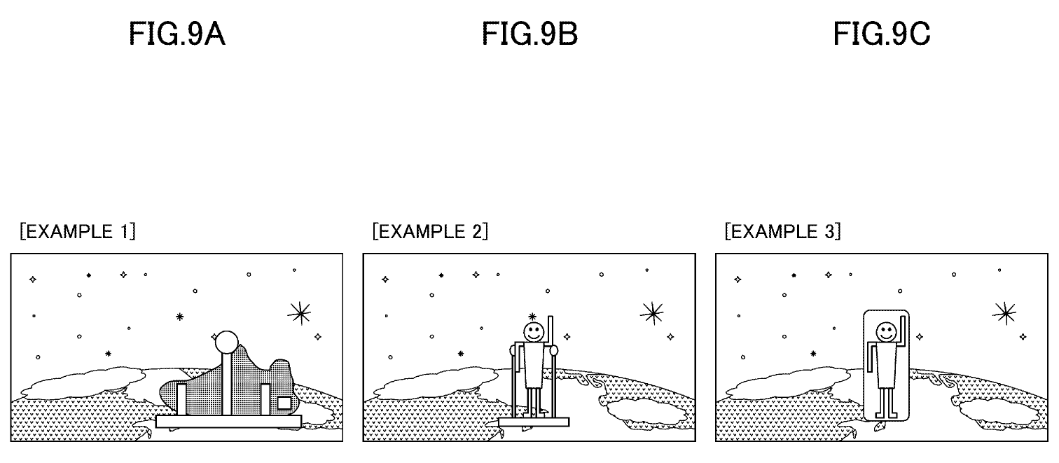

Thus, by measuring a product (e.g., a newly developed product) of a company under a desired condition, the product in outer space can be evaluated (product test). Further, for example, as Example 1 in FIG. 9A, an image of a product of a company as an object can be captured against a background of space. Thus, the video recording of the product of the company captured in outer space can be utilized for advertising and promotion activities of the product.

Further, an entertainment service can be provided in which a video recording of a doll (i.e., a figure) is captured in outer space under conditions specified by a user and allows the captured video recording to be viewed. For example, as Examples 2 and 3 in FIGS. 9B and 9C, respectively, the video recording of the doll (figure) against a background of outer space while the doll performs a user-specified movement can be captured. As Example 2 in FIG. 9B, an actual doll may be arranged in a satellite and moved by the robot arm, or as Example 3 in FIG. 9C, a video recording of the doll may be projected on a liquid crystal monitor or a hologram projector arranged in the satellite and moved. The video recording acquired from the satellite 40 and computer graphics may be synthesized. By using video recordings and the like as described above, for example, the following services may be provided.
On-demand distribution or live-stream distribution (hereinafter, “distribution” includes both) of video recordings captured by imaging the doll (i.e., figure) in outer space under desired conditions, or synthesized video recordings obtained by synthesizing video recordings captured in outer space with computer graphics of a virtual idol.
Uploading, by a user, a vote or a message relating to the doll (figure) or a virtual idol from the user terminal 20 to the server 10.
Periodic transmission, by a satellite, of messages generated within the satellite (for example, messages generated using artificial intelligence (AI)), diaries (for example, information indicating above which location on Earth the doll (figure) or a virtual idol is present), and stories relating to space, to the user terminal 20 via the server 10.
Real-time communication, such as chatting, between a user and the doll (figure) or a virtual idol.
Generation of a music video using video recordings captured by imaging the doll (figure) in outer space under desired conditions, or synthesized video recordings obtained by synthesizing video recordings of outer space with computer graphics of a virtual idol.
Performance of a fashion show using a virtual idol and captured video recordings.
Distribution of images captured from outside a measuring device, the measuring device being configured as a space simulating a live venue or a catwalk.
Raising of a virtual pet.
Distribution of sounds generated in outer space as ambient sounds, or distribution of music created by an artist using such sounds.
Provision of STEM (science, technology, engineering, and mathematics) education.
Provision of a game in which a user can participate.

### Functional Configuration

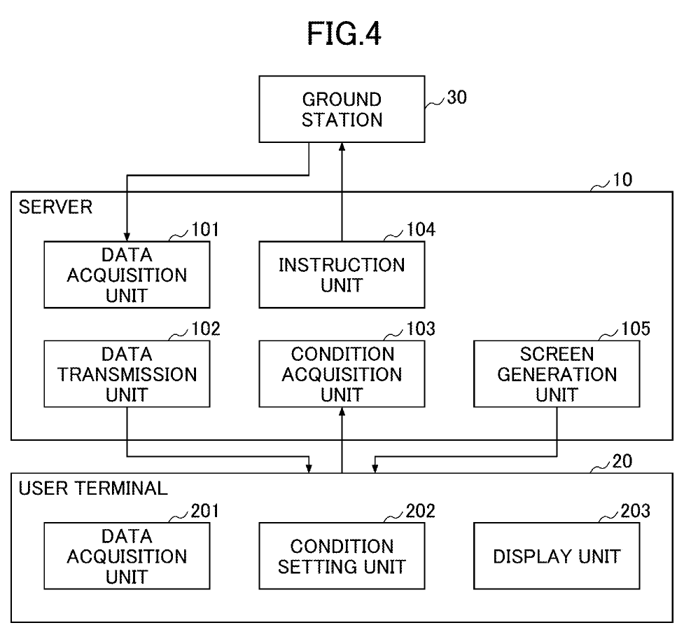

FIG. 4 is a functional block diagram illustrating the server 10 and the user terminal 20 according to one embodiment of the present disclosure.

### Server

The server 10 may include a data acquisition unit 101, a data transmission unit 102, a condition acquisition unit 103, an instruction unit 104, and a screen generation unit 105. The server 10 may function as the data acquisition unit 101, the data transmission unit 102, the condition acquisition unit 103, the instruction unit 104, and the screen generation unit 105 by executing a program.

The data acquisition unit 101 acquires at least one of measurement data and video data from the satellite 40. Specifically, the data acquisition unit 101 receives at least one of measurement data and video data received by the ground station 30 from the satellite 40 from the ground station 30.

The data transmission unit 102 transmits the data acquired from the satellite 40 to the user terminal 20. Specifically, the data transmission unit 102 transmits the data acquired by the data acquisition unit 101 to the user terminal 20.

The condition acquisition unit 103 acquires an instruction specifying at least one of a measurement condition and a video-recording condition for the satellite 40 from the user terminal 20. Specifically, the condition acquisition unit 103 acquires an instruction of at least one of a measurement condition and a video-recording condition for the satellite 40 input by the user to the user terminal 20 from the user terminal 20.

The instruction unit 104 transmits the instruction specifying the condition acquired from the user terminal 20 to the satellite 40. Specifically, the instruction unit 104 transmits the conditions acquired by the condition acquisition unit 103 to the ground station 30, and requests the ground station 30 to instruct the satellite 40 to perform measurement or a video recording under the conditions acquired by the condition acquisition unit 103.

The screen generation unit 105 generates a screen and causes the user terminal 20 to display the generated screen. The screen may include data transmitted by the data transmission unit 102 to the user terminal 20. A screen displayed on the user terminal 20 will be described below. Note that the following plural screens may be combined and displayed on one screen.

### Measurement Data and Video Data, and Instruction Screen for Measurement Condition and Video-Recording Condition

For example, the screen generation unit 105 causes the user terminal 20 to display, on one screen, measurement data and video data (specifically, a video recording captured inside the satellite 40 (in the case of Example 1 of FIG. 2A) and a video recording captured from the outside of the satellite 40 (in the case of Example 2 of FIG. 2B)) from the satellite 40, and a screen region for receiving the instruction specifying the at least one of a measurement condition and a video-recording condition for the satellite 40.

### Position Information

For example, the screen generation unit 105 causes the user terminal 20 to display current position information of the satellite 40 with respect to Earth. Note that the screen generation unit 105 can also cause the user terminal 20 to display current position information, with respect to Earth, of another satellite associated with the satellite on which the object is measured or captured, the other satellite being, for example, a satellite on which a product belonging to the same group, such as another product of the same company, is measured or captured. When the satellite 40 approaches the user’s residential area, an alert may be issued to the user terminal 20 to notify the user. As a result, the user can view, from Earth’s surface, a satellite associated with the user passing overhead.

For example, the screen generation unit 105 causes the user terminal 20 to display future (e.g., in one day, one week, and one month) position information of the satellite 40 with respect to Earth.

### Measurement Data and Video Data, and Current Position Information of Satellite

For example, the screen generation unit 105 causes the user terminal 20 to display at least one of the measurement data and video data (specifically, the video recording captured inside the satellite 40 (in the case of Example 1 of FIG. 2A) and the video recording captured from the outside of the satellite 40 (in the case of Example 2 of FIG. 2B)) from the satellite 40 and the current position information of the satellite 40 with respect to Earth on one screen. The screen generation unit 105 can cause the user terminal 20 to display the current position information of a plurality of satellites 40. For example, when the data from the satellite 40 is data measured or captured at each of a plurality of satellites (i.e., a plurality of measuring devices 41) and acquired by the ground station 30 from one communication device 42, the screen generation unit 105 can cause the user terminal 20 to display the position information of the plurality of satellites (i.e., a plurality of measuring devices 41).

### Current Measurement Condition and Video-Recording Condition, and Instructing Screen for Measurement Condition and Video-Recording Condition

For example, the screen generation unit 105 may cause the user terminal 20 to display a screen including at least one of the measurement data and the video data from the satellite 40 and the current position information of the satellite 40 with respect to Earth, and a screen for specifying at least one of the conditions when the measurement data is measured and the conditions when the video data is captured, and at least one of the conditions for measurement and the conditions for video-recording by the satellite 40.

It is also possible to simultaneously cause the user terminal 20 to display the video recording captured inside the satellite 40 (in the case of Example 1 of FIG. 2A) and the video recording captured from outside the satellite 40 (in the case of Example 2 of FIG. 2B), or to allow the user to switch between them.

### User Terminal

The user terminal 20 may include a data acquisition unit 201, a condition setting unit 202, and a display unit 203. The user terminal 20 can function as a data acquisition unit 201, a condition setting unit 202, and a display unit 203 by executing a program.

The data acquisition unit 201 acquires at least one of measurement data and video data from the satellite 40 via the server 10. Specifically, the data acquisition unit 201 receives at least one of measurement data and video data received by the server 10 from the ground station 30 from the server 10.

The condition setting unit 202 instructs at least one of measurement conditions and video-recording conditions for the satellite 40 to the satellite 40 via the server 10. Specifically, the condition setting unit 202 transmits an instruction of at least one of measurement conditions and video-recording conditions for the satellite 40 input by the user to the user terminal 20 to the server 10, and requests that the ground station 30 instructs the satellite 40 to perform measurement or video recording under the conditions.

The display unit 203 displays the data acquired from the server 10.

Here, each data and each condition will be described in detail.

### Measurement Data

The measurement data is a result of measuring the object mounted on the satellite 40.

### Video Data

The video data includes a video recording of the object mounted on the satellite 40. The video data may be the video recording captured inside the satellite (Example 1 of FIG. 2A) or the video recording captured from outside the satellite (Example 2 of FIG. 2B). The video recording of the object mounted on the satellite 40 may show a video recording of outer space or a celestial body such as Earth, the moon, or stars in a background behind the object.

The video recording acquired from the satellite 40 and computer graphics may be synthesized. Specifically, the screen generation unit 105 of the server 10 synthesizes the video recording captured inside the satellite or the video recording captured from outside the satellite and computer graphics (e.g., computer graphics representing the virtual idol) and transmits the synthesized video recording to the user terminal 20. The measuring device 41 may synthesize the video recording. When the object does not move, a generative AI may be used to synthesize a dance motion or song of the computer graphics.

### Measurement Conditions

For example, the measurement condition includes a measurement type and a measurement parameter (i.e., what type of measurement is performed and what type of parameters are used). Further, for example, the measurement condition includes an environmental condition inside the satellite (an environmental condition outside the satellite, such as a direction, speed, and altitude of the satellite with respect to Earth, may be used).

For example, the user can specify a type of measurement (e.g., vibration test, impact test, durability level, EMC test, acoustic test, and color measurement) and the measurement parameters (e.g., how much vibration or impact should be applied).

For example, the user can specify the conditions (e.g., temperature, humidity, atmospheric pressure, air composition, amount of radiation (ultraviolet, infrared, etc.), and ultraviolet wavelength range inside the satellite) of the internal environment of the satellite. An environment control device for changing these internal environments is provided inside the satellite and is controlled by the control device 401.

Because the user can specify and change these environmental conditions and measurement conditions, even when satisfactory data cannot be obtained under initially set conditions, the user can freely change the conditions in accordance with the result and perform the measurement again.

### Video-Recording Conditions

For example, the video-recording condition is a condition (e.g., the position, orientation, and movement of the object) regarding a state of the object mounted on the satellite. For example, the robot arm provided in the measuring device 41 can change the position and direction of the object. Further, for example, the video-recording condition is an environmental condition (e.g., lighting inside a satellite) inside the satellite.

For example, the video-recording condition is a condition (e.g., whether to capture still images or video recordings, what image quality to use for capturing images, and the position and orientation of the imaging device) regarding the imaging device 43.

### Processing Method

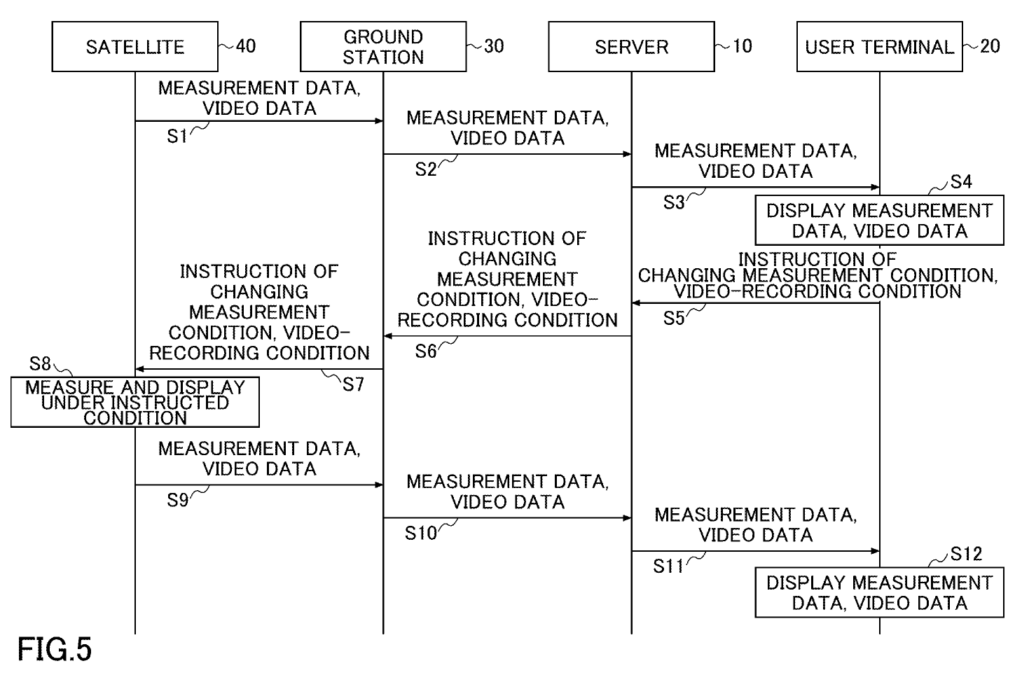

FIG. 5 is a sequence diagram illustrating acquisition of measurement data and video data and instructions specifying a measurement condition and a video-recording condition according to one embodiment of the present disclosure. It is assumed that the satellite 40 performs measurement and a video recording under any conditions (e.g., initially set condition) before changing the conditions.

In step 1 (S1), the satellite 40 (specifically, the communication device 42) transmits at least one of the measurement data and the video data to the ground station 30.

In step 2 (S2), the ground station 30 transmits the measurement data and the video data received in S1 to the server 10.

In step 3 (S3), the server 10 transmits the measurement data and the video data received in S2 to the user terminal 20.

In step 4 (S4), the user terminal 20 displays the measurement data and the video data received in S3.

In step 5 (S5), the user terminal 20 transmits instructions specifying at least one of the measurement condition and the video-recording condition by the satellite 40 to the server 10.

In step 6 (S6), the server 10 transmits the instruction received in S5 to the ground station 30.

In step 7 (S7), the ground station 30 transmits the instruction received in S6 to the satellite 40.

In step 8 (S8), the satellite 40 performs measurement and a video recording in accordance with the instructions received in S7. Specifically, the measuring device 41 of the satellite 40 performs measurement under the condition received in S7. The imaging device 43 of the satellite 40 performs a video recording under the condition received in S7.

In step 9 (S9), the satellite 40 (specifically, the communication device 42) transmits at least one of the measurement data, the video data (i.e., the result of measurement and video-recording in accordance with instructions from the user) to the ground station 30.

In step 10 (S10), the ground station 30 transmits the measurement data and the video data received in S9 to the server 10.

In step 11 (S11), the server 10 transmits the measurement data and the video data received in S10 to the user terminal 20.

In step 12 (S12), the user terminal 20 displays the measurement data and the video data received in S11.

### User Interface

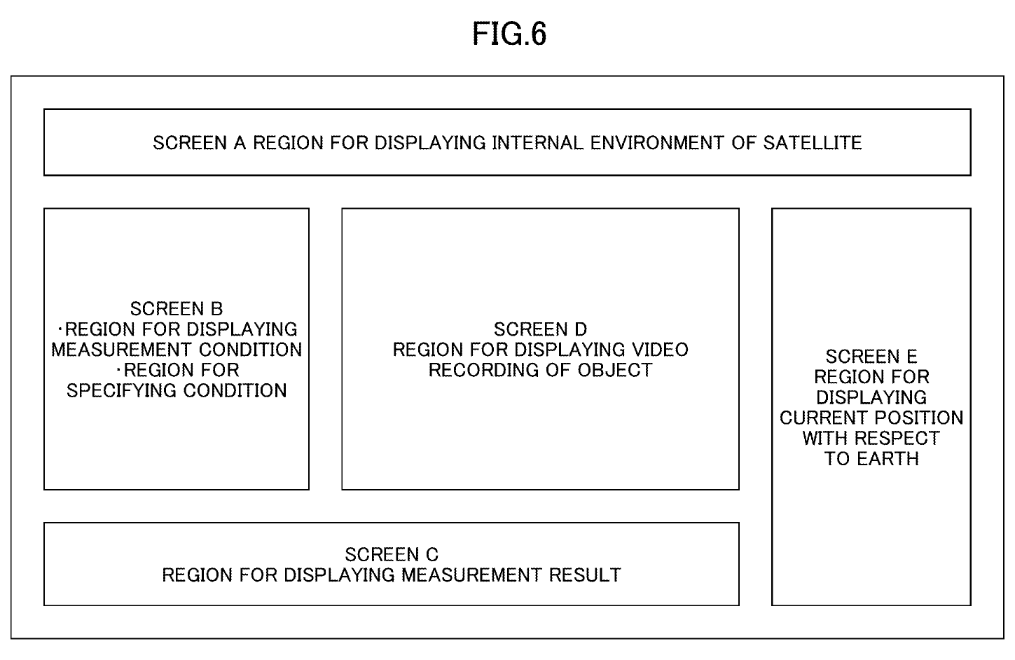

An example of a screen displayed on the user terminal 20 will be described with reference to FIGS. 6 to 9C.

FIG. 6 is an example of a screen displayed on the user terminal 20 when the object (e.g., a company’s product) mounted on a satellite is measured. As shown in FIG. 6, the device includes a region for displaying the internal environment of the satellite (screen A), a region for displaying the current measurement condition and transmitting instruction specifying the measurement condition (screen B), a region for displaying the measurement result (screen C), a region for displaying a video recording in which the image of the object is captured (screen D), and a region for displaying the current position of the satellite with respect to Earth (screen E).

On the screen A, information (e.g., temperature, humidity, atmospheric pressure, air composition, amount of radiation (ultraviolet, infrared, etc.), ultraviolet wavelength range, etc., inside the satellite) indicating the current internal environment of the satellite is displayed. Further, information indicating the current external environment of the satellite (e.g., temperature, humidity, atmospheric pressure, air composition, amount of radiation (ultraviolet, infrared, etc.), and ultraviolet wavelength range inside the satellite) may be displayed. Further, elapsed time from the launch, a moving speed, an amount of a storage battery, power generation efficiency, communication radio wave intensity, and the like may be displayed.

On the screen B, the current measurement conditions and a screen for instructing (e.g., change) the measurement conditions are displayed. Further, the current video-recording condition and a screen for instructing (e.g., change) the video-recording condition may be displayed.

On the screen C, the result of measuring the object mounted on the satellite (i.e., the results of the satellite’s sensors) is displayed. For example, the result of the vibration test, the result of the impact test, the durability level, and the result of the EMC test are displayed.

On the screen D, the video recording (real-time video recording) of the object mounted on the satellite is displayed.

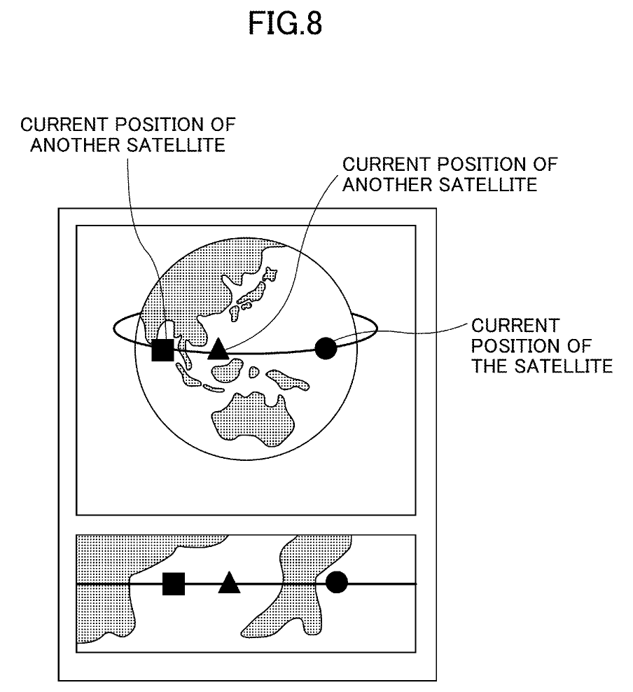

A screen E displays the current position of each satellite on a video recording representing Earth as a sphere or a video recording representing Earth as a plane. Details will be described later with reference to FIG. 8.

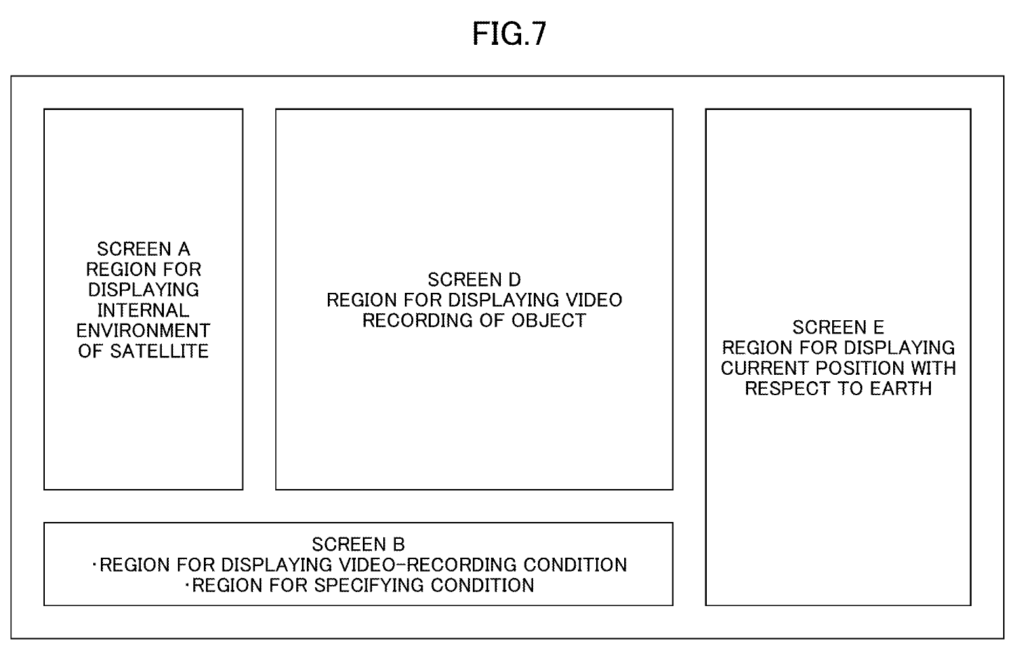

FIG. 7 is an example of a screen displayed on the user terminal 20 when capturing the image of the object (e.g., a doll (figure)) mounted on the satellite. As shown in FIG. 7, the device includes a region for displaying the internal environment of the satellite (screen A), a region for displaying the current measurement condition and transmitting instruction specifying the measurement condition (screen B), a region for displaying a video recording in which a video recording of the object is captured (screen D), and a region for displaying the current position of the satellite with respect to Earth (screen E).

On the screen A, information (e.g., temperature, humidity, atmospheric pressure, air composition, amount of radiation (ultraviolet, infrared, etc.), ultraviolet wavelength range, etc., inside the satellite) indicating the current internal environment of the satellite is displayed. Further, information indicating the current external environment of the satellite (e.g., temperature, humidity, atmospheric pressure, air composition, amount of radiation (ultraviolet, infrared, etc.), and ultraviolet wavelength range inside the satellite) may be displayed. Further, elapsed time from the launch, a moving speed, an amount of a storage battery, power generation efficiency, communication radio wave intensity, and the like may be displayed.

On the screen B, the current measurement conditions and a screen for instructing (e.g., change) the measurement conditions are displayed.

On the screen D, the video recording (real-time video recording) of the object mounted on the satellite is displayed.

On the screen E, the current position of each satellite on an image representing Earth as a sphere or an image representing Earth in a planar manner is displayed. Details will be described later with reference to FIG. 8.

FIG. 8 is an example of the screen E (a screen displaying the position of a satellite with respect to Earth) of FIGS. 6 and 7.

For example, as shown in the upper part of FIG. 8, current positions of respective satellites relative to Earth (i.e., positions above which locations on Earth the respective satellites are present) are shown on an image representing Earth as a sphere. For example, the longitude, latitude, address, altitude, and moving speed of each satellite may be shown.

For example, as shown in the upper part of FIG. 8, current positions of respective satellites relative to Earth (i.e., positions above which locations on Earth the respective satellites are present) are shown on an image representing Earth in a planar manner (e.g., an image illustrating orbits). For example, the longitude, latitude, address, altitude, and moving speed of each satellite may be shown. For example, the longitude, latitude, address, altitude, and moving speed of each satellite may be shown.

By viewing a screen as shown in FIG. 8, the user can confirm above which location on Earth the satellite which mounts the user’s object or another satellite other than the satellite is present.

FIGS. 9A to 9C are drawings illustrating an example of the screen D (region for displaying a video recording in which the object is captured) of FIGS. 6 and 7. It is assumed that there is a transparent part in the satellite. As in Example 1 of FIG. 9A, a video recording of a company’s product in the satellite with outer space and Earth as the background may be displayed. As in Example 2 of FIG. 9B, a video recording of a real doll (which may be moved by the robot arm) in the satellite with outer space and Earth as the background may be displayed. As in Example 3 of FIG. 9C, a video recording of a liquid crystal monitor or a hologram projector (the video of the doll is projected and the doll may be moved) in the satellite with outer space and Earth as the background may be displayed.

### Poor Communication Conditions between Satellite and Ground Station

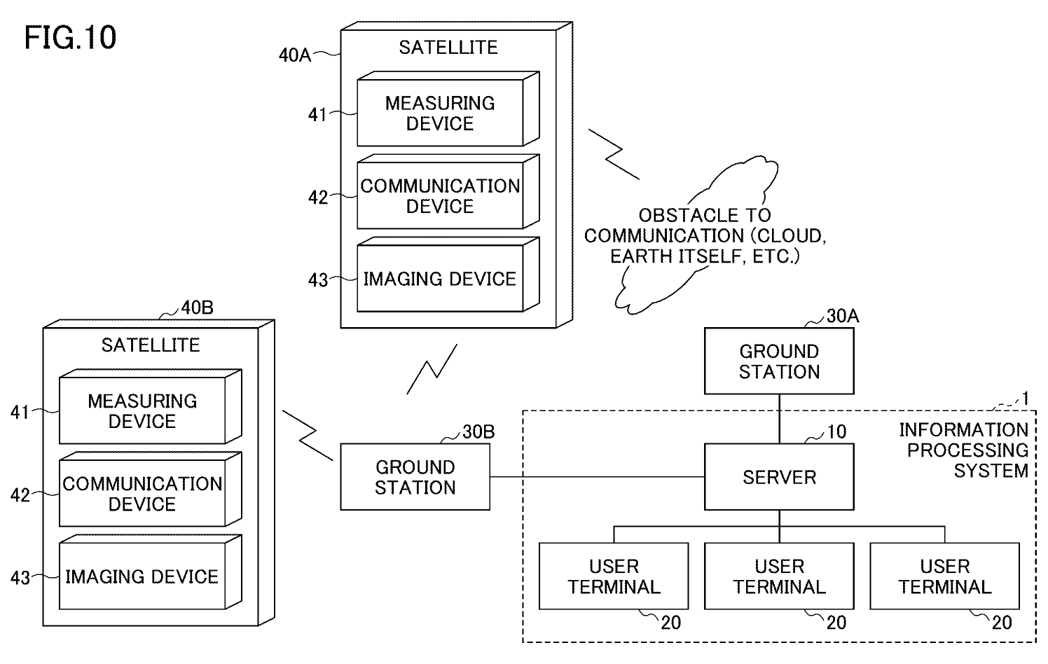

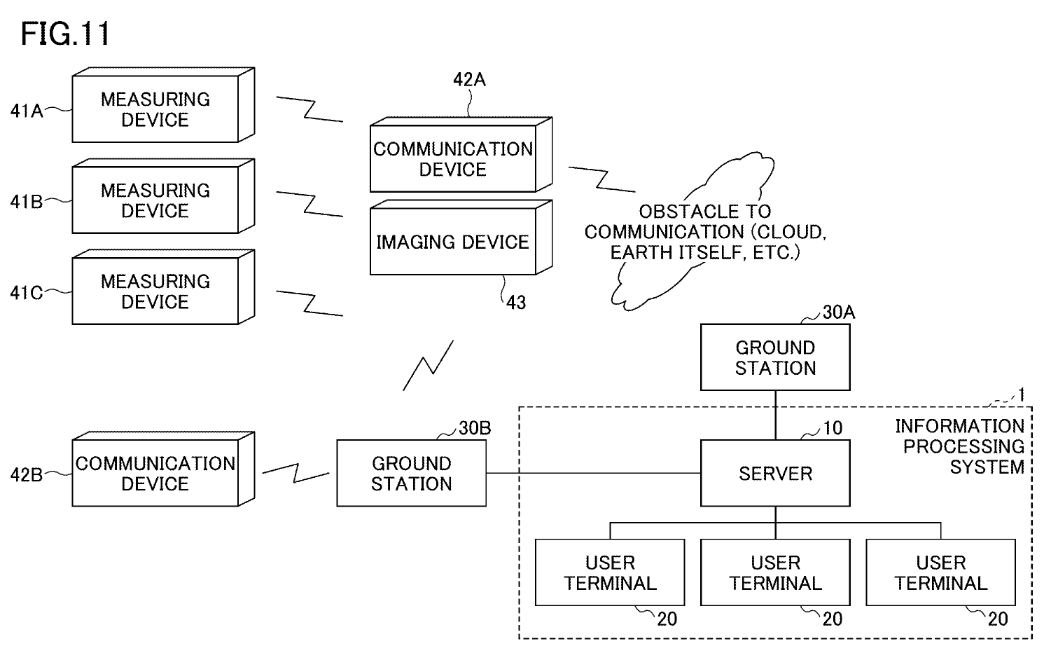

A communication medium used when communication conditions between the satellite and the ground station are poor will be described with reference to FIGS. 10 and 11.

FIG. 10 is a drawing for explaining a communication medium when communication conditions between the satellite 40 and the ground station 30 are poor when the measuring device 41, the communication device 42, and the imaging device 43 are implemented in a single satellite as in Example 1 of FIG. 2A.

Assume that a satellite 40A normally (i.e., when communication conditions are good) communicates (transmits and receives data) with a ground station 30A. When the communication conditions between the satellite 40A and the ground station 30A are poor, the communication is performed via a communication medium different from normal. For example, the communication device 42 of the satellite 40A transmits measurement data and video data to a ground station 30B different from the normally-used ground station 30A. For example, the communication device 42 of the satellite 40A transmits measurement data and video data to the communication device 42 of a satellite 40B different from itself (subsequently, the communication device 42 of the satellite 40B transmits the measurement data and the video data received from the communication device 42A to one of the ground stations 30).

FIG. 11 is a drawing for explaining a communication medium when communication conditions between the satellite 40 and the ground station 30 are poor when the measuring device 41, the communication device 42, and the imaging device 43 are separately implemented as in Example 2 of FIG. 2B.

Assume that a communication device 42A receives measurement data measured by measuring devices 41A to 41C or receives video data captured by the imaging device 43. Assume that the communication device 42A normally (i.e., when the communication condition is good) communicates (transmits and receives data) with a ground station 30A. When the communication conditions between the communication device 42A and the ground station 30A are poor, communication is performed via a communication medium different from normal. For example, the communication device 42A transmits measurement data and video data to the ground station 30B different from the normally-used ground station 30A. For example, the communication device 42A transmits measurement data and video data to a communication device 42B different from itself (subsequently, the communication device 42B transmits the measurement data and the video data received from the communication device 42A to one of the ground stations 30).

### Launch and Recovery of Satellites

For example, a plurality of satellites (measuring devices 41) are launched together, released, and recovered when the measurement and the video recording are completed. For example, the satellites return at a timing determined by a predetermined setting, an instruction from Earth, or artificial intelligence (AI). The measuring device 41 may be provided with a heat-resistant panel (material resistant to atmospheric entry) for recovery on the ground, an apogee motor, a thruster, a parasail, a rotor blade, or the like for landing or water impact at a predetermined position.

### Other Embodiments

Although an embodiment in which the user inputs a measurement condition or a video-recording condition to the user terminal 20 has been described above, the user terminal 20 or the server 10 may determine an appropriate condition (e.g., using artificial intelligence (AI)) and use the appropriate condition.

### Effect

As described above, according to one embodiment of the present disclosure, the user can obtain not only measurement data and video data from the satellite, but also measurement data and video data obtained under the measurement conditions and video-recording conditions desired by the user.

### Hardware Configuration

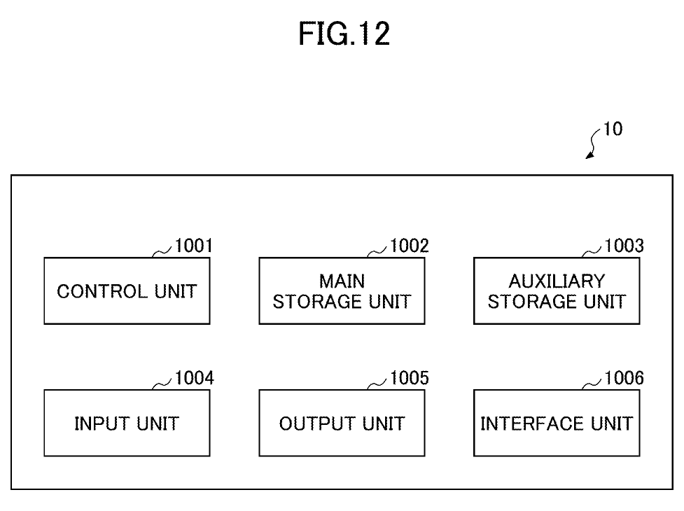

FIG. 12 is a hardware configuration diagram of the server 10 according to one embodiment of the present disclosure. The same applies to the user terminal 20.

The server 10 may include a control unit 1001, a main storage unit 1002, an auxiliary storage unit 1003, an input unit 1004, an output unit 1005, and an interface unit 1006. Each will be described below.

The control unit 1001 is a processor (e.g., Central Processing Unit (CPU), Graphics Processing Unit (GPU)) for executing various programs installed in the auxiliary storage unit 1003.

The main storage unit 1002 includes a nonvolatile memory (ROM (Read Only Memory)) and a volatile memory (RAM (Random Access Memory)). The ROM stores various programs and data necessary for the control unit 1001 to execute various programs installed in the auxiliary storage unit 1003. The RAM provides a working area used when various programs installed in the auxiliary storage unit 1003 are executed by the control unit 1001.

The auxiliary storage unit 1003 is an auxiliary storage device for storing various programs and information used when the various programs are executed.

The input unit 1004 is an input device for an operator of the server 10 to input various instructions to the server 10.

The output unit 1005 is an output device for outputting the internal state or the like of the server 10.

The interface unit 1006 is a communication device for connecting to a network and communicating with other devices.

Each of the functions of the embodiments described above can be achieved by one or more processing circuits. Here, the term “processing circuit” in this specification includes a processor programmed to execute each function by software, such as a CPU (Central Processing Unit) or a GPU (Graphics Processing Unit) implemented by an electronic circuit, and apparatuses such as an ASIC (Application Specific Integrated Circuit), a DSP (Digital Signal Processor), an FPGA (Field Programmable Gate Array) and conventional circuit modules designed to execute each of the functions described above.

Further, the present disclosure is not limited to these embodiments, and various variations and modifications may be made without departing from the scope of the present disclosure.

What is claimed is:

1. An information processing system comprising a server and a user terminal, wherein the server includes circuitry configured to cause the user terminal to display, on one screen, data from a satellite, the data being current position information of the satellite with respect to Earth and at least one of measurement data or video data.

2. The information processing system according to claim 1, wherein:
the data from the satellite is data measured or captured at each of a plurality of satellites and acquired by a ground station from one communication device; and
the circuitry is configured to cause the user terminal to display current position information of the plurality of satellites.

3. The information processing system according to claim 1, wherein the circuitry is configured to cause the user terminal to display at least one of a measurement condition or a video-recording condition, the measurement condition being used during measurement of the measurement data, and the video-recording condition being used during recording of the video data.

4. The information processing system according to claim 1, wherein the circuitry is configured to cause the user terminal to display a screen for receiving an instruction regarding at least one of a measurement condition or a video-recording condition for the satellite.

5. The information processing system according to claim 1, wherein the measurement data is a result of measuring an object mounted on the satellite.

6. The information processing system according to claim 1, wherein the video data includes a video recording of an object mounted on the satellite.

7. The information processing system according to claim 6, wherein the video recording of the object mounted on the satellite shows a video recording of outer space or Earth in a background behind the object.

8. The information processing system according to claim 6, wherein the video recording of the object mounted on the satellite shows a video recording of the object mounted on the satellite captured from outside the satellite.

9. The information processing system according to claim 1, wherein:
the video data includes a video recording captured inside the satellite or a video recording captured from outside the satellite; and
the circuitry is configured to transmit a video recording obtained by synthesizing the video recording captured inside the satellite or the video recording captured from outside the satellite and computer graphics to the user terminal.

10. The information processing system according to claim 4, wherein the measurement condition includes either (i) a combination of a measurement type and a measurement parameter, (ii) an environmental condition inside the satellite, or both (i) and (ii).

11. The information processing system according to claim 4, wherein the video-recording condition is at least one of a condition regarding a state of an object mounted on the satellite or an environmental condition inside the satellite.

12. The information processing system according to claim 4, wherein the video-recording condition is a condition regarding an imaging device.

13. A server comprising circuitry configured to cause a user terminal to display, on one screen, data from a satellite, the data being current position information of the satellite with respect to Earth and at least one of measurement data or video data.

14. A user terminal comprising circuitry configured to display, on one screen, data from a satellite, the data being current position information of the satellite with respect to Earth and at least one of measurement data or video data.

15. A service providing method comprising causing a user terminal to display, on one screen, data from a satellite, the data being current position information of the satellite with respect to Earth and at least one of measurement data or video data.
